(19) United States
(12) Patent Application Publication
(10) Pub. No.: US 2019/0281974 A1
(43) Pub. Date: Sep. 19, 2019

(54) Lap Pillow

(71) Applicant: Eva Bella Karacsony, Closter, NJ (US)

(72) Inventor: Eva Bella Karacsony, Closter, NJ (US)

(21) Appl. No.: 16/356,266

(22) Filed: Mar. 18, 2019

Related U.S. Application Data
(60) Provisional application No. 62/643,849, filed on Mar. 16, 2018.

(51) Int. Cl. A47B 23/00; A61G 5/10

(52) U.S. Cl. CPC A47B 23/002; A61G 5/1094

(57) ABSTRACT

A lap pillow designed to secure devices atop a pillow in a lap. The lap pillow includes a lunic member defined by an exterior circular arc having an outer diameter and an outer apex overlapping an interior circular arc having an inner diameter and an inner apex aligned with the outer apex, wherein the exterior circular arc intersects the interior circular arc at two discrete points aligned with one another such that a convex-convex area is formed therebetween the exterior circular arc and the interior circular arc. A plurality of elastic straps are disposed atop the lunic member converge at an apex of the lunic member. At least one clasp is disposed along a perimeter of the lunic member. In this way, a user is able to secure devices atop a pillow in a reachable position to improve the user experience for those with limited access.

### CROSS REFERENCE TO RELATED APPLICATIONS

This application claims the benefit of U.S. Provisional Application No. 62/643,849 filed on Mar. 16, 2018. The above identified patent application is herein incorporated by reference in its entirety to provide continuity of disclosure.

### BACKGROUND OF THE INVENTION

The present invention relates to lap pillows. More specifically, the invention provides a lunic member defined by two converging arcs intersecting at two discrete points with a plurality of elastic straps disposed atop and at least one clasp along a perimeter thereof.

Many people are born with physical or mental disabilities, giving them limited ability to control their motor functions, such as when the individual suffers from cerebral palsy. Additionally, others without such disabilities can have difficulty with coordination or general weakness, such as young children and the elderly. Often, these individuals enjoy playing with toys, reading a book, or using a personal electronic device. However, it can be difficult for them to perform these mundane tasks, as they may not be able to adequately manipulate or hold the device. While it is possible a nurse or assistant could hold the device for them, this can be frustrating or upsetting to the individual when their independence is desired. Thus, an improved lap pillow that can efficiently provide convenience for the user when desiring to secure devices like toys or books atop a pillow in an easily reachable position when seated for those users with limited access.

### SUMMARY OF THE INVENTION

In view of the foregoing disadvantages inherent in the known types of lap pillows now present in the known art, the present invention provides a lap pillow wherein the same can be utilized for providing convenience for the user when desiring to secure devices like toys or books atop a pillow in a reachable position to improve the user experience for those with limited access.

The present system comprises a lap pillow. The lap pillow comprises a lunic member defined by an exterior circular arc having an outer diameter and an outer apex overlapping an interior circular arc having an inner diameter and an inner apex aligned with the outer apex, wherein the exterior circular arc intersects the interior circular arc at two discrete points aligned with one another such that a convex-convex area is formed therebetween the exterior circular arc and the interior circular arc. A plurality of elastic straps are disposed atop the lunic member converge at an apex of the lunic member. At least one clasp is disposed along a perimeter of the lunic member. In this way, a user is able to secure devices atop a pillow in a reachable position to improve the user experience for those with limited access.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a front view of an embodiment of the lap pillow.

FIG. 1B shows a rear view of an embodiment of the lap pillow.

FIG. 2 shows a perspective view of an embodiment of lap pillow with indicia inscribed thereon.

FIG. 3 shows a perspective view of an embodiment of the lap pillow in use.

### DETAILED DESCRIPTION OF THE INVENTION

Reference is made herein to the attached drawings. Like reference numerals are used throughout the drawings to depict like or similar elements of the lap pillow. The figures are intended for representative purposes only and should not be considered to be limiting in any respect.

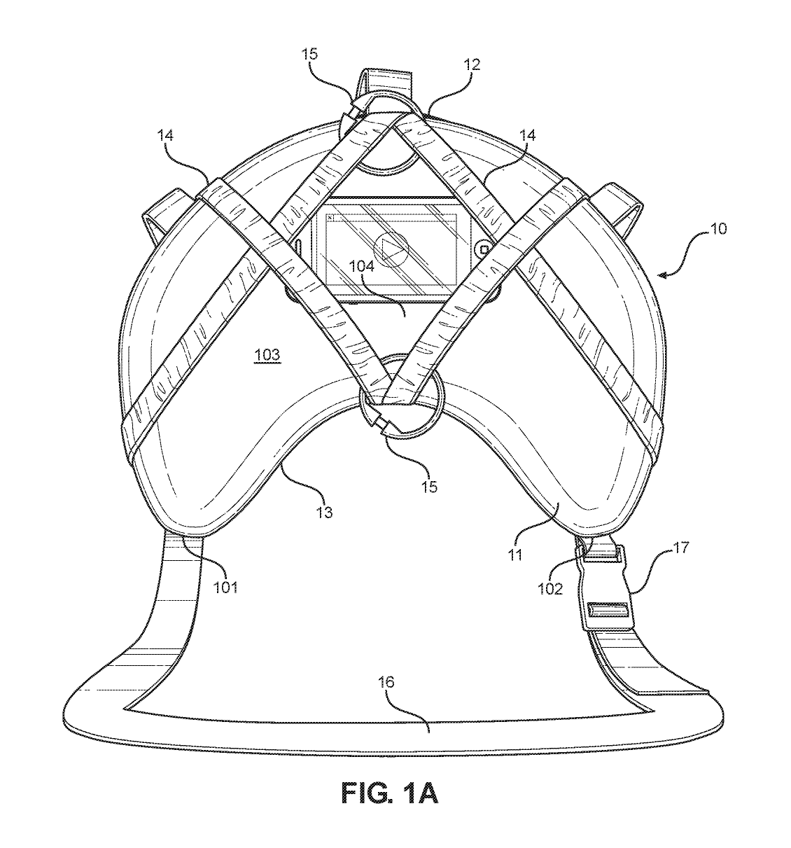

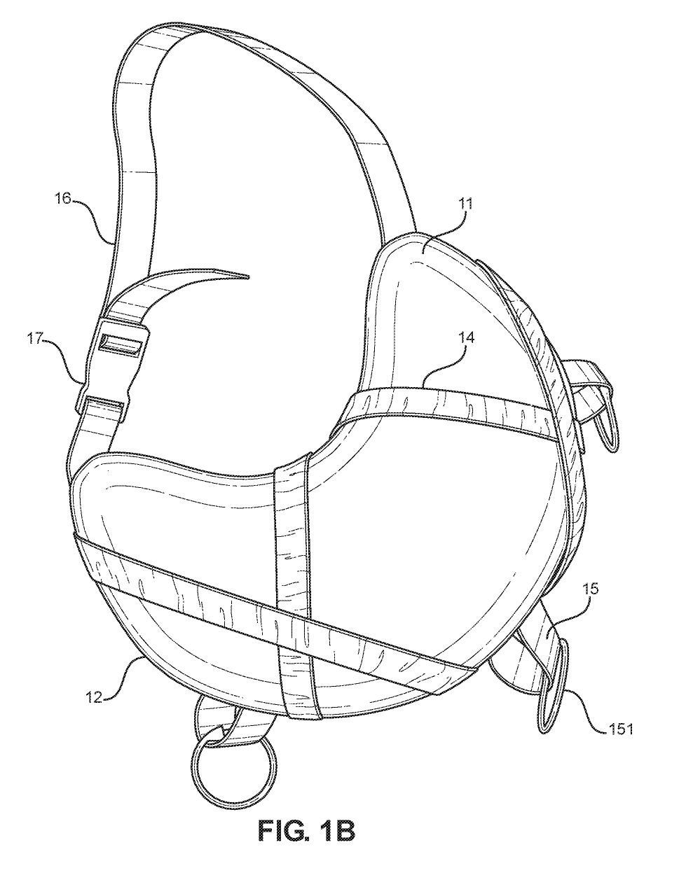

Referring now to FIG. 1A, there is shown a front view of an embodiment of the lap pillow. A lap pillow 10 comprises a lunic member 11, defined by an exterior circular arc 12 overlapping an interior circular arc 13. The exterior circular arc 12 and interior circular arc 13 intersect at a first intersecting point 101 and at a second intersecting point 102. In the illustrated embodiment, the first intersecting point 101 and the second intersecting point 102 are aligned with one another, such that the lunic member 11 is symmetrical about a midline of the lunic member 11. In this way, the lunic member 11 comprises a convex-convex area formed between the exterior circular arc 12 and the interior circular arc 13. In this way, an upper surface of the lap pillow 10 and a lower surface of the lap pillow 10 comprise a rounded shape to provide increased comfort and padding to a user. The exterior circular arc 12 has an outer diameter, whereas the interior circular arc 13 has an inner diameter, such that the inner diameter is configured to rest flush against a torso of a user. Similarly, the exterior circular arc 12 includes an outer apex, whereas the interior circular arc 13 includes an inner apex. Thus, the convex-convex shape of lunic member 11 ensures the outer apex of the exterior circular arc 12 is aligned with the inner apex of the interior circular arc 13.

The lunic member 11 includes an external surface 103. In the illustrated embodiment, the external surface 103 is composed of an easy to clean material with a friction coefficient greater than one, such as rubber or plastic, thereby allowing a user to rest items atop the external surface 103 without worrying about the items slipping off and can easily clean the surface should it become dirty.

A plurality of elastic straps 14 are disposed around the lunic member 11, wherein the elastic straps 14 are biased towards the lunic member 11. In this way, the elastic straps 14 rest flush against the external surface 103 when not in use and exert a force against an object placed therein, such that the object is secured to the lunic member 11. The elastic straps 14 are composed of an elastic or stretchy material, such that the user can pull an elastic strap 14 outwardly from the lunic member 11 to place an item thereon, allowing the elastic strap 14 to secure the item in place. The elastic straps 14 are configured to meet at an apex of the lunic member 11. In the illustrated embodiment, the elastic straps 14 meet at both the outer apex of the exterior circular 12 and the inner apex of the interior circular arc 13, such that a secure holding area is formed at a center 104 of the lunic member 11, where an item can be secured using multiple elastic straps 14. In the illustrated embodiment, a mobile device, such as a smartphone, is removably secured to the lunic member 11 via the elastic straps 14 at the center 104 thereof. In some embodiments, the lunic member 11 further comprises weighted element therein. The weighted element is configured to provide emotional grounding to individuals with sensory processing disorders, such as anxiety, autism, and the like.

At least one clasp 15 is disposed along a perimeter of the lunic member 11. In the illustrated embodiment, a clasp 15 is positioned at the interior apex with an additional clasp 15 positioned at the exterior apex. In the shown embodiment, each clasp 15 is configured to unlatch, such as via a carabiner system, such that a user can place or more toys or rings within the clasp 15. In this way, a child utilizing the lap pillow 10 can play with the item attached to the clasp 15 without fear of losing or misplacing the toy.

In the shown embodiment, the lap pillow 10 further comprises a securing strap 16, having a first end affixed to the first intersecting point 101 and a second end affixed to the second intersecting point 102. In the illustrated embodiment, the securing strap 16 is permanently affixed to the lunic pillow 11 at the first intersecting point 101 and the second intersecting point 102. However, in other embodiments, the securing strap 16 is removably secured to the lunic pillow 11. In the shown embodiment, the securing strap 16 further comprises a fastener 17, such that the securing strap 16 can be detached to secure around the torso of the user. In other embodiments, the securing strap 16 is adjustable in length, such as via a buckle system.

Referring now to FIG. 1B, there is shown a rear view of an embodiment of the lap pillow. In the shown embodiment, the plurality of elastic straps 14 are disposed on the rear side of the lunic member 11, such that the lunic member 11 can be rotated by 180-degrees and secured using the securing strap 16 and fastener 17, thereby allowing for the user to utilize the rear side as well as the front side illustrated in FIG. 1A, providing the user with additional variability and choice in use.

In the illustrated embodiment, the clasps 15 are disposed along the exterior circular arc 12 of the lunic member 11, and are composed of a sewn material, such that the clasps 15 are securely affixed to the lunic member 11 and permanently positioned along the exterior circular arc 12. Thus, in the shown embodiment, additional removable clasps 151 are affixed to the clasps 15. In this way, the user can continue to utilize the removable clasps 151 as previously described without fear the clasps 15 may break due to reinforced use or distress, should a child continually pull on the toy affixed to the clasps 15. In some embodiments, the clasps 15 are disposed along the outer exterior circular arc 12 at regular intervals, thereby ensuring that toys or other objects secured thereto are evenly distributed about the lap pillow.

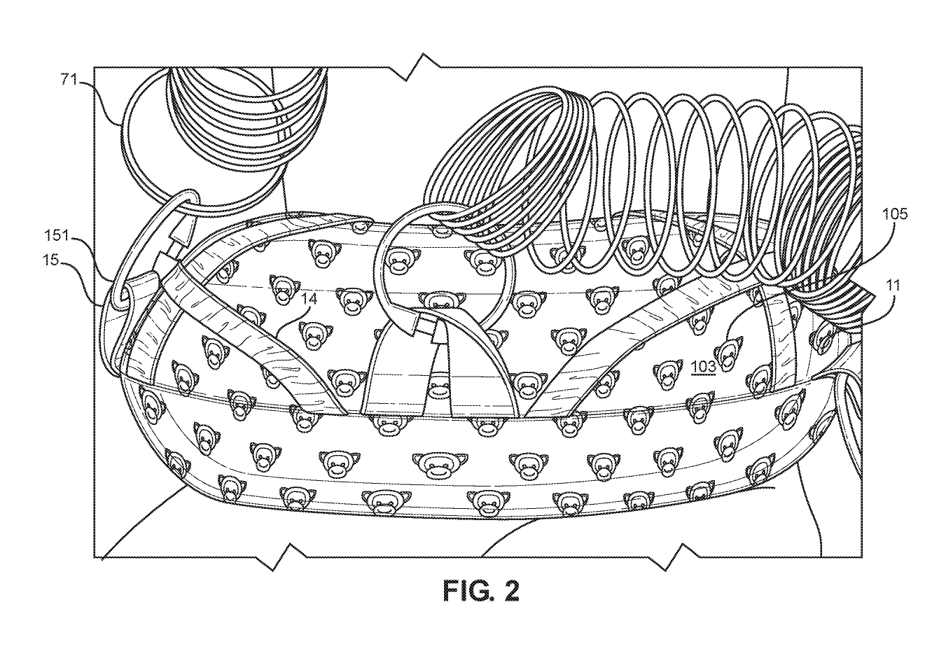

Referring now to FIG. 2, there is shown a perspective view of an embodiment of lap pillow with indicia inscribed thereon. In the illustrated embodiment, a user can choose to decorate their lap pillow via indicia 105 inscribed on the external surface 103 of the lunic member 11. In this way, a person using the lap pillow can be made to feel more comfortable through the decoration of a friendly or calming indicium 105 inscribed on the lunic member 11. In alternate embodiments, the indicia 105 disposed across the external surface 103 can be replicated along the elastic straps 14, such that the elastic straps 14 maintain the pattern of the lunic member 11.

Furthermore, in the illustrated embodiment, a toy is removably secured to the removable clasp 151 affixed to the clasp 15. In this way, the user can easily grasp and interact with the toy, without fear of the toy being lost, dropped, or otherwise misplaced. Additionally, the toy can be removably secured to the removable clasp 151 via a spring 71 or alternate securing mechanism, thereby ensuring that the toy returns to the lunic member 11 in the event of the toy being dropped. In some embodiments, the spring 71 is removably secured to the clasp 15 and can receive a toy thereon via a removable clasp 151 attached thereto.

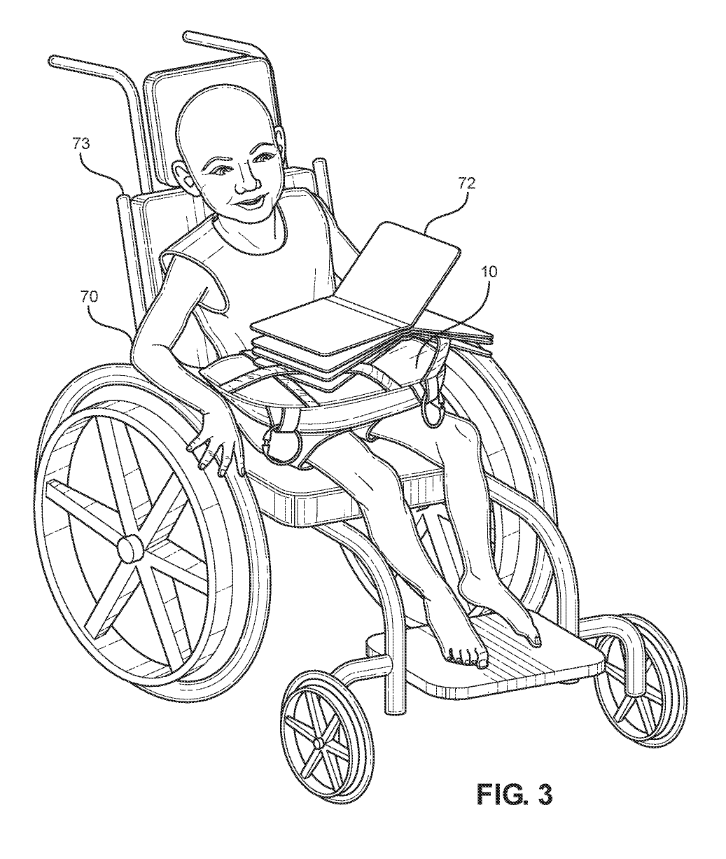

Referring now to FIG. 3, there is shown a perspective view of an embodiment of the lap pillow in use. In operation, a person will orient the lap pillow 10 such that the lunic member is atop the lap of the user 70 and the interior circular arc is positioned flush against the torso of the user 70. The lunic member can then be secured into place using the securing strap to enclose the body of the user 70 as well as any chair 73 the user 70 may be sitting in. One or more items 72 can be secured to the lunic member using the elastic straps. In this way, an individual can easily utilize a plurality of devices using a comfortable lap pillow.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A lap pillow comprising:
a lunic member defined by an exterior circular arc overlapping an interior circular arc, wherein the exterior circular arc intersects the interior circular arc at two discrete points aligned with one another such that a convex-convex area is formed therebetween the exterior circular arc and the interior circular arc;
wherein the exterior circular arc has an outer diameter and the interior circular arc has an inner diameter;
wherein the exterior circular arc has an outer apex and the interior circular arc has an inner apex;
wherein the outer apex is aligned with the inner apex;
a plurality of elastic straps disposed atop the lunic member converging at an apex of the lunic member;
at least one clasp disposed along a perimeter of the lunic member.

2) The lap pillow of claim 1, further comprising a securing strap having a first end affixed to a first intersecting point of the exterior circular arc and the interior circular arc and a second end affixed to a second intersecting point of the exterior circular arc and the interior circular arc.

3) The lap pillow of claim 2, wherein the first end of the securing strap is permanently affixed to the first intersecting point and the second end of the securing strap is permanently affixed to the second intersecting point.

4) The lap pillow of claim 3, wherein the securing strap further comprises a removably securable fastener.

5) The lap pillow of claim 2, wherein the securing strap is adjustable in length.

6) The lap pillow of claim 1, wherein the outer diameter is greater than the inner diameter.

7) The lap pillow of claim 1, wherein lunic member includes an external surface composed of a dirt repellant material with a friction coefficient greater than one.

8) The lap pillow of claim 1, wherein indicia is inscribed on an exterior surface of the lunic member.

9) The lap pillow of claim 1, wherein the elastic straps converge at the outer apex.

10) The lap pillow of claim 1, wherein the elastic straps converge at the inner apex.

11) The lap pillow of claim 1, wherein the lunic member is symmetrical about a midline extending between the outer apex and the inner apex.

12) The lap pillow of claim 1, wherein each clasp is disposed about the exterior circular arc at regular intervals.
